(19) United States
(12) Patent Application Publication
(10) Pub. No.: US 2007/0286064 A1
(43) Pub. Date: Dec. 13, 2007

(54) Transmission/reception apparatus and method for supporting both high rate packet data transmission and orthogonal frequency division multiplexing transmission in a mobile communication system

(75) Inventors: Jae-Chon Yu, Suwon-si (KR); Dong-Hee Kim, Yongin-si (KR); Hwan-Joon Kwon, Hwaseong-si (KR); Yu-Chul Kim, Seoul (KR); Jin-Kyu Han, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/725,592

(22) Filed: Mar. 19, 2007

(30) Foreign Application Priority Data
Mar. 17, 2006 (KR) 24832-2006

(51) Int. Cl. H04J 9/00

(52) U.S. Cl. 370/204

(57) ABSTRACT

A transmission apparatus for transmitting packet data in a forward link of a High Rate Packet Data (HRPD) system is disclosed. The apparatus includes a first transmission processor for modulating physical link packet data according to an Orthogonal Frequency Division Multiplexing (OFDM) transmission scheme; a second transmission processor for modulating the physical link packet data according to a Evolution Data Only (EV-DO) transmission scheme; an HRPD-compatible processor for generating a transmission signal based on a slot structure of the HRPD system using one of output signals of the first and second transmission processors, and transmitting the transmission signal to a wireless network; and a controller for controlling transmission of the transmission signal according to a selected one of the OFDM transmission scheme and the EV-DO transmission scheme.

### PRIORITY

This application claims priority under 35 U.S.C. § 119(a) to a Korean Patent Application filed in the Korean Intellectual Property Office on Mar. 17, 2006 entitled “Transmission/Reception Apparatus and Method For Supporting Both High Rate Packet Data Transmission And Orthogonal Frequency Division Multiplexing Transmission In A Mobile Communication System” and assigned Serial No. 2006-24832, the disclosure of which is incorporated herein by reference.

### BACKGROUND OF THE INVENTION

1. Field of the Invention

The present invention relates generally to an apparatus and method for transmitting/receiving data in a Multi-Carrier High Rate Packet Data (hereafter referred to Nx HRPD) system, and in particular, to a transmission/reception apparatus and method for supporting not only an Evolution Data Only (EV-DO) transmission scheme but also an Orthogonal Frequency Division Multiplexing (OFDM) transmission scheme in the Nx HRPD system.

2. Description of the Related Art

With the rapid progress of communication technologies; mobile communication systems have developed to the point where they provide not only the general voice call service but also high-speed data services capable of transmitting high-volume digital data such as moving image as well as e-mail and still image, to mobile terminals.

EV-DO and OFDM systems are typical examples of the current mobile communication systems supporting the high-speed data services. The OFDM system, one of the high-speed data service standards proposed by Qualcomm for transmission of high-volume digital data, has evolved from the conventional CDMA 2000 1× by one step to provide a forward data rate of about 2.4 Mbps. The OFDM system is also known as an HRPD system.

An OFDM transmission scheme is one of the typical wireless mobile communication systems employing multi-carrier transmission scheme. The OFDM transmission scheme, a scheme for converting a serial input symbol stream into parallel streams and then modulating them with multiple orthogonal subcarriers before transmission, has started to attract attention with the development of Very Large Scale Integration (VLSI) technology since the early 1990s.

The OFDM transmission scheme, as it modulates data using multiple orthogonal subcarriers, shows high robustness against frequency selective multipath fading channel, compared with the conventional single-carrier modulation scheme, and this transmission scheme is suitable for HRPD services such as broadcast services.

A brief description will now be made of a slot structure and a transmitter structure in a forward link of a general Nx HRPD system.

The forward link of the Nx HRPD system uses Time Division Multiple Access (TDMA) technique as a multiple access technique, and Time Division Multiplexing (TDM)/Code Division Multiplexing (CDM) technique as a multiplexing technique.

FIG. 1 illustrates a slot structure of a forward link in an Nx HRPD system to which the present invention is applicable.

As illustrated in FIG. 1, one slot has a repeated form of half-slot structures. A pilot signal 101 with an Nₚᵢₗₒₜ-chip length is inserted in the center of the half slot, and this is used for channel estimation of a forward link at a receiver of a mobile terminal. Medium Access Control (MAC) signals 102 and 103 with an N_{MAC}-chip length, including reverse power control information and resource allocation information, are transmitted at both sides of the pilot signal 101. In addition, actual transmission data 104 and 105 with N_{Data}-chip length are transmitted at both sides of MAC signals 102 and 103. In this manner, in the HRPD system, slots of the forward link are multiplexed by TDM in which pilot, MAC information, and data are transmitted at different times.

The MAC information is multiplexed by CDM using Walsh codes, and in the forward link of the HRPD system, small-block sizes of a pilot signal, a MAC signal, and data are set to Nₚᵢₗₒₜ=96 chips, N_{MAC}=64 chips, and N_{Data}=400 chips, respectively.

FIG. 2 is a block diagram of a transmitter in an Nx HRPD system to which the present invention is applicable.

Referring to FIG. 2, the transmitter includes a channel encoder 201 for channel-encoding received packet data, a channel interleaver 202 for interleaving the coded packet data, and a modulator 203 for modulating the interleaved packet data. Data on a MAC channel passes through a channel encoder 205. Pilot signal, MAC signal, and data are transmitted as a physical link signal having the slot structure shown in FIG. 1, after passing through a TDM multiplexer (MUX) 206. The data, after passing through TDM multiplexer 206, is transmitted to a mobile terminal via an antenna (not shown) through a carrier modulator 207. In FIG. 2, reference numeral 208 indicates an HRPD-compatible processor including channel encoder 205 for a MAC channel, TDM multiplexer 206 and carrier modulator 207, for compatibility with the Nx HRPD system.

However, the foregoing Nx HRPD system may not sufficiently support broadband data transmission and promote efficient use of frequency resources, both required in the next generation communication system that provides broadcast services. In order to support them, there is a need for a high-speed data transmission scheme and efficient use of frequency resources with use of an appropriate data modulation method.

### SUMMARY OF THE INVENTION

An aspect of the present invention is to address at least the above described problems and/or disadvantages and to provide at least the advantages described below. Accordingly, an aspect of the present invention is to provide a transmission/reception apparatus and method in a mobile communication system supporting both synchronous HRPD transmission and OFDM transmission.

Another aspect of the present invention is to provide a transmission/reception apparatus and method for providing transmission scheme information to a mobile terminal in a mobile communication system supporting both a synchronous HRPD system and an OFDM system.

According to one aspect of the present invention, there is provided a transmission apparatus for transmitting packet data in a forward link of a High Rate Packet Data (HRPD) system. The apparatus includes a first transmission processor for modulating physical link packet data according to an Orthogonal Frequency Division Multiplexing (OFDM) transmission scheme; a second transmission processor for modulating the physical link packet data according to an Evolution Data Only (EV-DO) transmission scheme; an HRPD-compatible processor for generating a transmission signal based on a slot structure of the HRPD system using a signal output from one of the first and second transmission processors, and transmitting the transmission signal to a wireless network; and a controller for controlling transmission of the transmission signal according to one of the OFDM transmission scheme and the EV-DO transmission scheme.

According to another aspect of the present invention, there is provided a transmission method for transmitting packet data in a forward link of a High Rate Packet Data (HRPD) system. The method includes selecting one transmission scheme out of an Orthogonal Frequency Division Multiplexing (OFDM) transmission scheme and an Evolution Data Only (EV-DO) transmission scheme; modulating physical link packet data according to the selected transmission scheme; generating a transmission signal based on a slot structure of the HRPD system using the modulated packet data; and transmitting the transmission signal to a wireless network on a slot by slot basis.

According to a further aspect of the present invention, there is provided a reception apparatus for receiving packet data in a forward link of a High Rate Packet Data (HRPD) system. The apparatus includes an HRPD-compatible processor for receiving a forward link signal according to a slot structure of the HRPD system; a first reception processor for demodulating a received signal according to an Orthogonal Frequency Division Multiplexing (OFDM) transmission scheme; a second reception processor for demodulating a received signal according to an Evolution Data Only (EV-DO) transmission scheme; and a selector for selecting one of the first and second reception processors as a reception path according to a transmission scheme of the forward link signal.

According to yet another aspect of the present invention, there is provided a reception method for receiving packet data in a forward link of a High Rate Packet Data (HRPD) system. The method includes receiving a forward link signal which is transmitted with one transmission scheme out of an Orthogonal Frequency Division Multiplexing (OFDM) transmission scheme and an Evolution Data Only (EV-DO) transmission scheme according to a slot structure of the HRPD system; reading a transmission scheme indicator of the forward link signal; and demodulating the received forward link signal according to a transmission scheme corresponding to the read result.

### BRIEF DESCRIPTION OF THE DRAWINGS

The above and other aspects, features and advantages of the present invention will become more apparent from the following detailed description when taken in conjunction with the accompanying drawings in which:

FIG. 1 illustrates a slot structure of a forward link in an Nx HRPD system to which the present invention is applicable;

FIG. 2 is a block diagram of a transmitter in an Nx HRPD system to which the present invention is applicable;

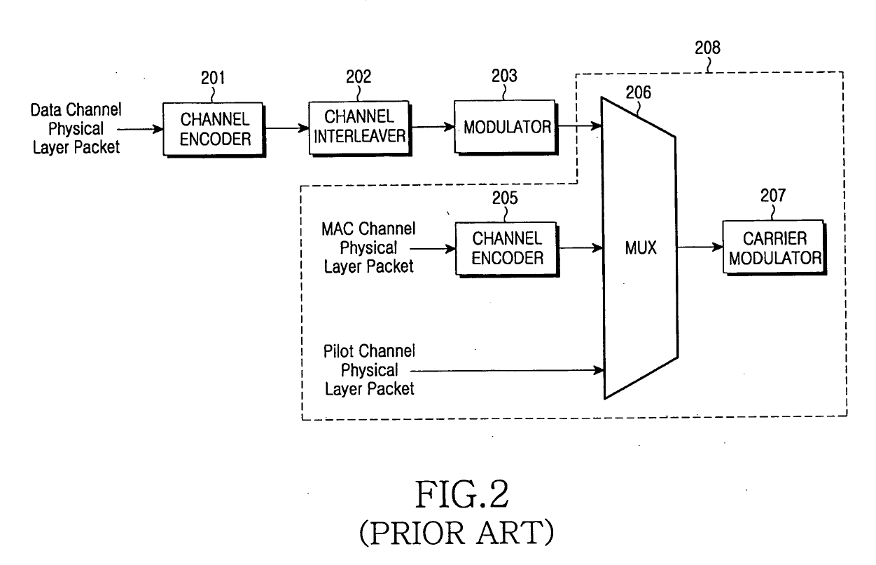

FIG. 3 illustrates a slot structure where an OFDM/EV-DO symbol is inserted in a data transmission interval in a forward link of an Nx HRPD-compatible system according to the present invention;

FIG. 4 illustrates a method for transmitting a transmission scheme indicator in an Nx HRPD-compatible system according to the present invention;

FIG. 5 illustrates a method for transmitting a transmission scheme indicator in an Nx HRPD-compatible system according to the present invention;

FIG. 6 illustrates a method for transmitting a transmission scheme indicator in an Nx HRPD-compatible system according to the present invention;

FIG. 7 is a block diagram of a transmitter in an Nx HRPD-compatible system according to the present invention;

FIG. 8 is a flow chart of a process of transmitting a transmission scheme indicator in a forward link according to the present invention;

FIG. 9 is a block diagram of a receiver in an Nx HRPD-compatible system according to the present invention; and

FIG. 10 is a flow chart of a reception process in a forward link of an Nx HRPD-compatible system according to the present invention.

### DETAILED DESCRIPTION OF PREFERRED EMBODIMENTS

Exemplary embodiments of the present invention will now be described in detail with reference to the annexed drawings. In the following description, detailed description of known functions and configurations incorporated herein has been omitted for clarity and conciseness.

A mobile communication system used herein is assumed as a CDMA 2000 Nx-HRPD system supporting an OFDM transmission scheme (hereafter, referred to Nx HRPD-compatible system). The present invention defines an OFDM/EV-DO transmission scheme indicator (hereafter, referred to transmission scheme indicator) to support both OFDM transmission scheme and EV-DO transmission scheme in a transmission slot of the Nx HRPD-compatible system, and provides a transmission/reception apparatus and method for transmitting/receiving the transmission scheme indicator in the Nx HRPD-compatible system.

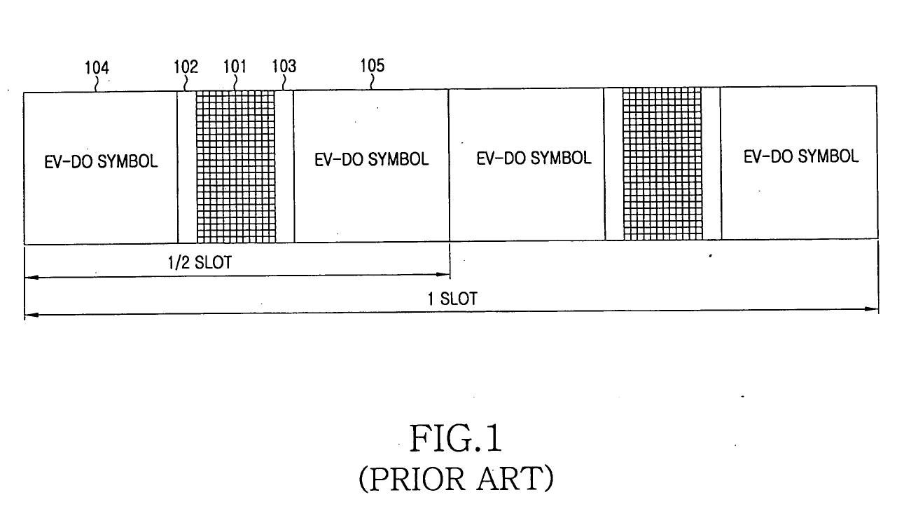

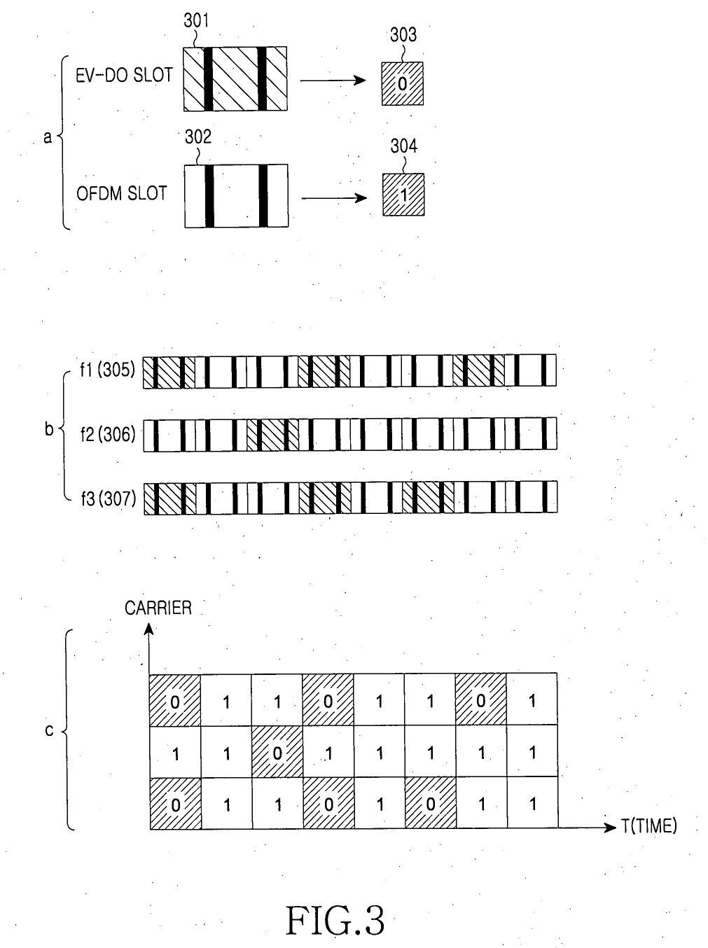

Referring to FIG. 3, there are shown a slot 301 using the EV-DO transmission scheme and a slot 302 using the OFDM transmission scheme. It is assumed that the Nx HRPD-compatible system is equal to the general Nx HRPD system in terms of the position and size of the pilot signal and the MAC signal in the slot structure of the forward link described in FIG. 1, in order to maintain the compatibility with the existing Nx HRPD system. That is, although not illustrated in FIG. 3, a pilot signal (shown by a black stripe) with an Nₚᵢₗₒₜ-chip length is located in the center of a half slot, and MAC signals (not shown) with an N_{MAC}-chip length are located in both sides of the pilot signal. Therefore, a general HRPD terminal not supporting the OFDM transmission scheme can also estimate a channel using the pilot signal transmitted with the above-described slot structure, and receive the MAC signals. In addition, an OFDM symbol or an EV-DO symbol is transmitted in the remaining interval, i.e. data transmission interval, of the slot.

In the slot structure of FIG. 3, because a data transmission interval is set to, for example, N_{Data}=400 chips, the size of the OFDM symbol is also N_{Data}=400 chips. The OFDM transmission scheme adds a Cyclic Prefix (CP) to the head of the OFDM symbol before transmission in order to prevent the possible self-interference caused by a received signal time-delayed through multiple paths. That is, one OFDM symbol is composed of a CP and OFDM data obtained by performing Inverse Fast Fourier Transform (IFFT) on packet data information. The size of the CP is N_{CP} chips, and for CP insertion, an N_{CP}-chip signal is copied from the rear of the OFDM data and then inserted in the front of the OFDM data. Therefore, the size of the OFDM data is (N_{Data}−N_{CP}) chips. N_{CP} is determined depending on the allowable time delay that causes the self-interference. If N_{CP} is greater, more received signals can be demodulated without interference, but the size of the OFDM data decreases causing a reduction in the possible amount of transmission information. However, if N_{CP} is smaller, the possible amount of transmission information increases, but probability of the self-interference occurring in a severe multipath fading environment increases, causing deterioration of reception quality. Therefore, not all of N_{Data} tones can be used for data symbol transmission, and some tones in the boundary of a frequency band are used as guard tones for preventing an out-band signal from serving as interference.

In performing communication between a base station and a terminal, the novel Nx HRPD-compatible system using the foregoing slot structure may differently use the EV-DO transmission scheme or the OFDM transmission scheme for the terminal in some slots according to each channel condition of multiple carriers.

Therefore, the proposed Nx HRPD-compatible system uses an indicator that provides, every slot, terminals with the information indicating the current use of the EV-DO transmission scheme or the OFDM transmission scheme.

For example, if the Nx HRPD system having a 5-MHz frequency band has three carriers each being compatible with the 1×HRPD system as shown in ‘b’ of FIG. 3, it can be assumed as an Nx-compatible HRPD system that supports HRPD with carriers f1 305, f2 306 and f3 307. In the Nx-compatible HRPD system, slots of each carrier can use the EV-DO transmission scheme or the OFDM transmission scheme according to channel condition of the carrier with the passage of time. If the EV-DO transmission scheme is expressed with ‘0’ and the OFDM transmission scheme is expressed with ‘1’ as shown in ‘a’ of FIG. 3, a transmission scheme indicator for the three carriers can be expressed as 010, 111, 101, . . . , as shown in ‘c’ of FIG. 3, at an arbitrary time t.

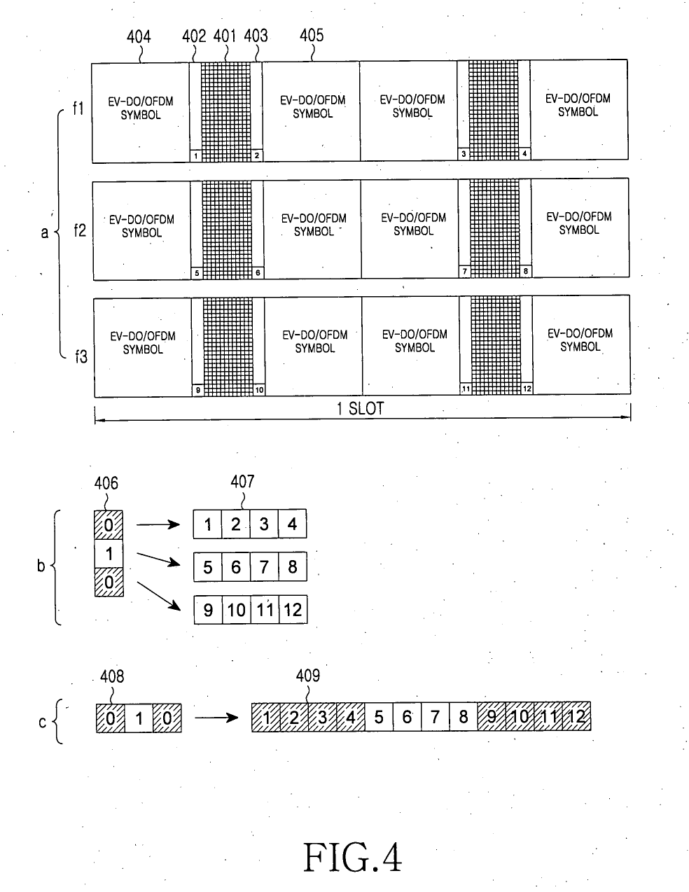

Referring to FIG. 4, reference numeral 401 denotes a pilot interval in which a pilot signal is transmitted, reference numerals 402 and 403 denote MAC intervals in which MAC signals are transmitted, and reference numeral 404 and 405 denote data transmission intervals.

In FIG. 4, a transmission scheme indicator for a transmission scheme, obtained at an arbitrary time t, has 3 information bits, which are mapped to carriers f1, f2 and f3 on which OFDM/EV-DO signals of the Nx HRPD-compatible system are transmitted, according to the present invention. This embodiment may use a first scheme for (12,3) block-coding: 3-bit information 408 for the transmission scheme into 12-bit information 409 as shown in ‘c’ of FIG. 4, and carrying 1 bit in each of the MAC intervals 402 and 403 shown in ‘a’ of FIG. 4, or a second scheme for (4,1) block-coding 1 bit of 3-bit information 406 into 4-bit information 407 separately for each of carriers f1, f2 and f3, as shown in ‘b’ of FIG. 4, and carrying 1 bit in each of the MAC intervals 402 and 403 shown in ‘a’ of FIG. 4.

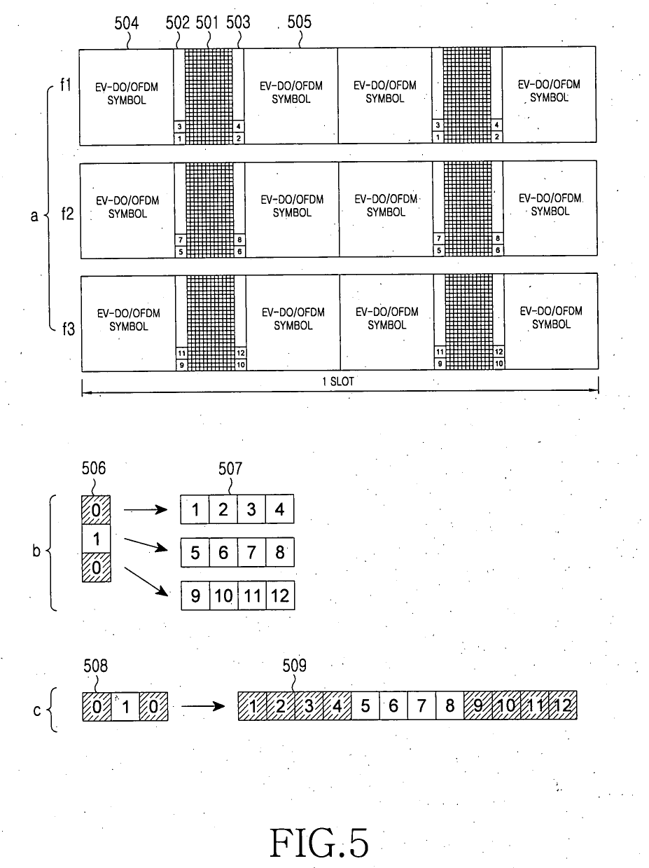

Referring to FIG. 5, reference numeral 501 denotes a pilot interval, reference numerals 502 and 503 denote MAC intervals, and reference numerals 504 and 505 denote data transmission intervals.

In FIG. 5, a transmission scheme indicator for a transmission scheme, obtained at an arbitrary time t, has 3 information bits, which are mapped to carriers f1, f2 and f3 on which OFDM/EV-DO signals of the Nx HRPD-compatible system are transmitted, according to the present invention. This embodiment may use a first scheme for (12,3) block-coding: 3-bit information 508 for the transmission scheme into 12-bit information 509 as shown in ‘c’ of FIG. 5, and carrying 2 bits in each of the MAC intervals 502 and 503 shown in ‘a’ of FIG. 5; or a second scheme for (4,1) block-coding: 1 bit of 3-bit information 506 into 4-bit information 507 separately for each of carriers f1, f2 and f3, as shown in ‘b’ of FIG. 5, and carrying 2 bit in each of the MAC intervals 502 and 503 shown in ‘a’ of FIG. 5. Although the foregoing embodiment transmits the same number of block-coded information bits in the two MAC intervals 502 and 503 as shown in FIG. 5, it is also possible to transmit all information bits for the corresponding carrier in one of the MAC intervals.

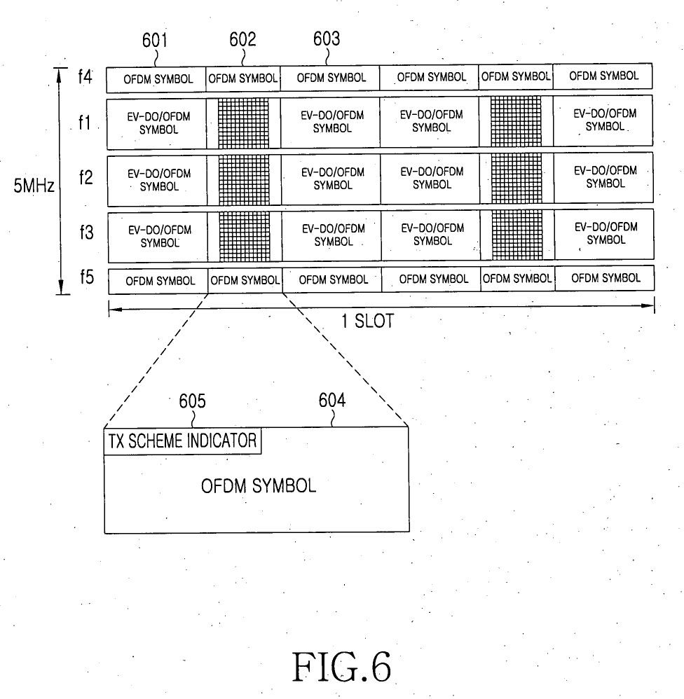

FIG. 6 shows an exemplary method for transmitting transmission scheme indicator in an Nx HRPD-compatible system that transmits OFDM/EV-DO signals having the slot structure of FIG. 4 or 5 through 3 carriers f1, f2 and f3 in the 5-MHz frequency band, and transmits OFDM signals through 2 carriers f4 and f5. The frequency band of carriers f4 and f5 can be less than the frequency band of carriers f1, f2 and f3. In FIG. 6, reference numerals 601 and 603 denote data transmission intervals, and reference numeral 602 denotes pilot and MAC intervals.

Referring to FIG. 6, a transmission scheme indicator for a transmission scheme, obtained at an arbitrary time t, has 3 information bits according to the present invention. Here, if information bits for the transmission scheme, i.e. transmission scheme indicator 605, cannot be transmitted as an Nx HRPD-compatible system OFDM/EV-DO signal after undergoing (12,3) block coding as shown in the embodiment of FIG. 4 or 5, transmission scheme indicator 605 can be inserted into an arbitrary OFDM symbol 604 among the OFDM symbols of carriers f4 and f5 in the corresponding slot interval, and then transmitted to a terminal. In the third embodiment of the present invention, transmission scheme indicator 605 can be inserted into OFDM symbol 604 after undergoing block coding. As another method, however, the indicator information can be transmitted along with a Priority Data Control Channel (PDCCH) or a Secondary Data Control Channel (SDCCH). The PDCCH or SDCCH transmits control information for reception of a data channel, and the proposed transmission scheme indicator can also be included in the data control information.

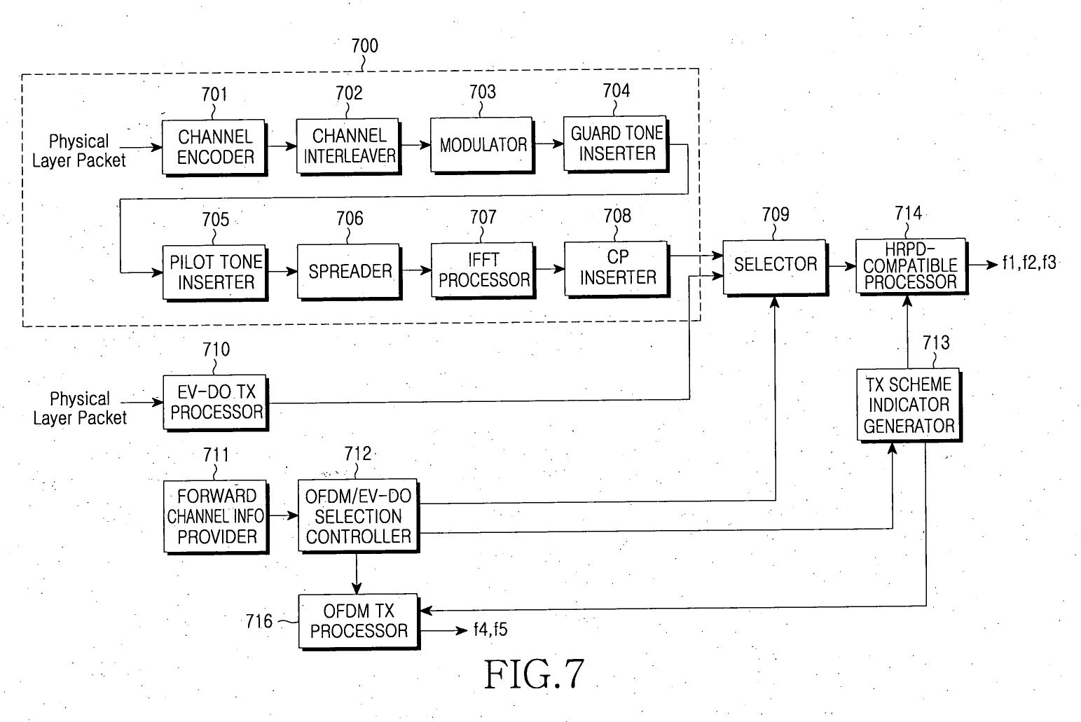

Referring to FIG. 7, the transmitter includes an OFDM transmission processor 700, an EV-DO transmission processor 710, and another OFDM transmission processor 716 having the same structure as the OFDM transmission processor 700. The OFDM transmission processor 700 and the EV-DO transmission processor 710 are for generating OFDM/EV-DO signals according to the slot structure of FIG. 4 or 5, and another OFDM transmission processor 716 is for generating OFDM signals for carriers f4 and f5 according to the slot structure of FIG. 6.

OFDM transmission processor 700 includes a channel encoder 701 for channel-encoding received packet data, a channel interleaver 702 for interleaving the coded packet data, a modulator 703 for modulating the interleaved packet data, a guard tone inserter 704 for inserting guard tones for preventing an out-band signal from serving as interference, and a pilot tone inserter 705 for inserting pilot tones.

In addition, OFDM transmission processor 700 includes a spreader 706, an Inverse Fast Fourier Transform (IFFT) processor 707 for converting a time-domain signal into a frequency-domain signal, and a CP inserter 708 for inserting a Cyclic Prefix (CP) in the front of OFDM data to prevent signal interference. For example, a Quadrature Phase Shift Keying (QPSK) spreader can be used for spreader 706.

Further, the transmitter includes an HRPD-compatible processor 714 for compatibility with a transmission scheme of the HRPD system, a selector 709 for selecting one of the EV-DO transmission scheme and the OFDM transmission scheme, a transmission scheme indicator generator 713 for generating a proposed transmission scheme indicator indicating a transmission scheme selected from an OFDM scheme and an EV-DO scheme by selector 709 and outputting information on the selected transmission scheme to HRPD-compatible processor 714, a selection controller 712 for controlling operations of selector 709 and transmission scheme indicator generator 713, and a forward channel information provider 711 for providing information on a forward channel to selection controller 712. Moreover, in order to support the embodiment of FIG. 3, the transmitter can optionally include an OFDM transmission processor 716 for inserting the transmission scheme indicator generated by the transmission scheme indicator generator 713 into OFDM symbols of carriers f4 and f5 shown in FIG. 6.

A description will now be made of a transmission process of the transmitter for the OFDM transmission scheme or the EV-DO transmission scheme.

Operations of the OFDM transmission processors 700 and 716 will first be described. Physical link packet data generated in an upper layer is input to channel encoder 701 where it is channel-encoded, and the channel-encoded bit stream is mixed (interleaved) through channel interleaver 702 to obtain diversity gain. The interleaved bit stream is input to modulator 703 where it is converted into a modulation signal. Herein, the modulation signal is arranged in data tones of data transmission interval 404 and 405 in the slot structure of FIG. 4, data tones of the data transmission interval 504 and 505 in the slot structure of FIG. 5, or data tones of data transmission interval 601 and 603 in the slot structure of FIG. 6. Guard tone inserter 704 arranges guard tones in the band boundary of the signal output from modulator 703. Pilot tone inserter 705 inserts a pilot signal in a predetermined position of the modulation signal before transmission. If transmission signals are allocated to all tones according to the above operation, spreader 706 performs, for example, QPSK spreading, and through the QPSK spreading process, signals of base stations that transmit different information are multiplied by different complex Pseudo Noise (PN) sequences. Herein, the complex PN sequence refers to a complex sequence in which its real component and imaginary component both are composed of PN codes. The modulation signal, after passing through the QPSK spreading, is placed in a position of a desired frequency tone after undergoing an IFFT process in IFFT processor 707. CP inserter 708 inserts a CP in the IFFT-processed OFDM data thereby generating an OFDM symbol, in order to prevent a self-interference effect due to multipath fading.

EV-DO transmission processor 710 performs encoding and modulation on the data transmitted from a physical link according to the standard of the Nx HRPD system, and allocates transmission data to a data channel. Here, an operation of generating a transmission signal according to the Nx HRPD slot structure is performed in HRPD-compatible processor 714.

Forward channel information provider 711 generates channel information indicating if a channel of a desired transmission slot is based on the OFDM transmission scheme or the EV-DO transmission scheme, and delivers the channel information to OFDM/EV-DO selection controller 712. Based on the channel information provided from forward channel information provider 711, OFDM/EV-DO selection controller 712 controls selector 709 for selecting a transmission scheme of EV-DO data (or OFDM data tone) including the desired transmission data, and transmission scheme indicator generator 713 for generating a set transmission scheme indicator according to the channel information.

When the transmitter transmits data according to the EV-DO transmission scheme, HRPD-compatible processor 714 TDM-multiplexes: (a) the data transmission interval on which EV-DO symbol delivered from the EV-DO transmission processor 710 via selector 709 is carried, (b) the MAC interval into which a transmission scheme indicator indicating that the transmission scheme is the EV-DO scheme is inserted, and (c) the pilot interval according to the slot structure of FIG. 4 or 5, and then allocates the multiplexing results to the forward channel.

However, when the transmitter transmits data according to the OFDM transmission scheme, HRPD-compatible processor 714 TDM-multiplexes: (a) the data transmission interval on which an OFDM symbol delivered from OFDM transmission processor 716 via selector 709 is carried, (b) the MAC interval into which a transmission scheme indicator indicating that the transmission scheme is the OFDM scheme is inserted, and (c) the pilot interval according to the slot structure of FIG. 4 or 5, and then allocates the multiplexing results to the forward channel.

When the transmitter supports the embodiment of FIG. 6, OFDM/EV-DO selection controller 712 inserts a transmission scheme indicator for carriers f1, f2 and f3, delivered from transmission scheme indicator generator 713, into an arbitrary OFDM symbol of carriers f4 and/or f5, generated by OFDM transmission processor 716.

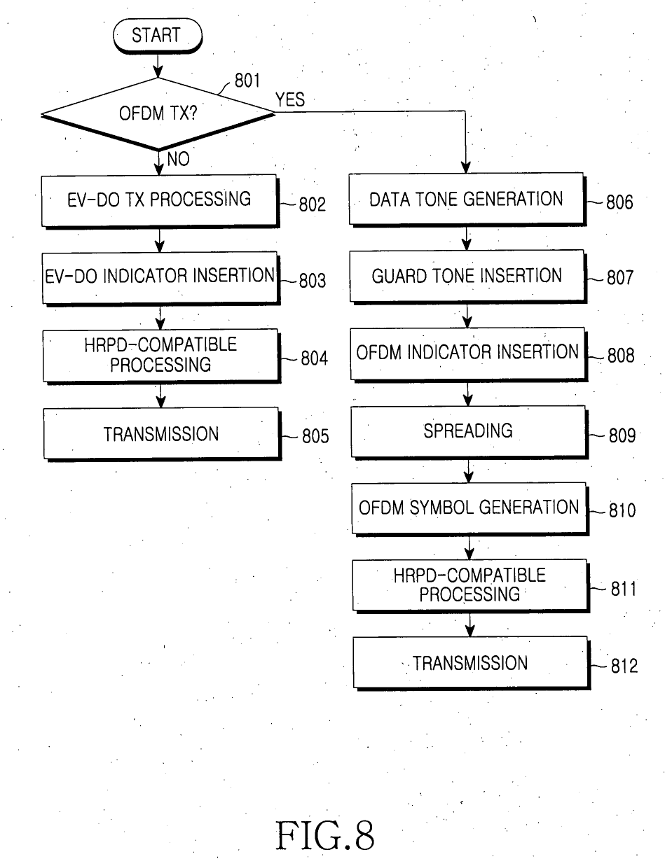

Referring to FIG. 8, the transmitter of a base station determines in step 801 if the transmission scheme of the current transmission slot is an OFDM scheme or an EV-DO scheme. Based on the determined transmission scheme indicator, the base station determines if the current transmission is OFDM transmission or EV-DO transmission, and performs an operation according to the corresponding transmission scheme. That is, if it is determined in step 801 that the current transmission scheme is the EV-DO transmission scheme, the transmitter proceeds to step 802 where it performs an EV-DO transmission process of encoding and modulating the desired transmission data, and allocating the modulated data to a data channel. Thereafter, in step 803, the transmitter inserts a transmission scheme indicator indicating the EV-DO transmission scheme, generated by a transmission scheme indicator generator 713, into a MAC interval in the slot structure of FIG. 4 or 5. In addition, when the transmitter supports the embodiment of FIG. 6, the transmitter inserts a transmission scheme indicator for providing a terminal with transmission scheme information of each carrier related to Nx HRPD compatible processing, into an arbitrary OFDM symbol of another carrier transmitted together with an EV-DO signal. Thereafter, in step 804, HRPD-compatible processor 714 of the transmitter performs an HRPD-compatible process of TDM-transmitting signals on a data transmission interval, a MAC interval including the transmission scheme indicator, and a pilot interval, for compatibility with the existing HRPD system. In step 805, the transmitter transmits the TDM-multiplexed EV-DO signal to a wireless network using a carrier.

However, if it is determined in step 801 that the current transmission scheme is the OFDM transmission scheme, the transmitter proceeds to step 806 where it encodes and interleaves transmission data and then modulates the interleaved data thereby generating data tones of an OFDM signal. Thereafter, a guard tone inserter 704 of the transmitter inserts in step 807 a guard tone in the band boundary of the modulation signal, and inserts in step 808 a transmission scheme indicator into a MAC interval in the slot structure of FIG. 4 or 5, the transmission scheme indicator generated by transmission scheme indicator generator 713 indicates the OFDM transmission scheme. In addition, when the transmitter supports the embodiment of FIG. 6, the transmitter inserts a transmission scheme indicator of each carrier related to Nx HRPD compatible processing, into an arbitrary OFDM symbol of another carrier transmitted together with an EV-DO signal. Thereafter, if transmission signals are allocated to all tones, a spreader 706 performs, for example, QPSK spreading in step 809, and the modulation signals, after passing through the QPSK spreading, are placed in a position of a desired frequency tone after undergoing a process in an IFFT processor 707. In step 810, a CP inserter 708 inserts a CP in the processed OFDM data thereby generating an OFDM symbol, in order to prevent a self-interference effect. Thereafter, in step 811, HRPD-compatible processor 714 of the transmitter performs a HRPD-compatible process of TDM-transmitting the data transmission interval, the MAC interval including, and the pilot interval, for compatibility with the existing HRPD system. In step 812, the transmitter transmits the TDM-multiplexed signal to a wireless network using a carrier.

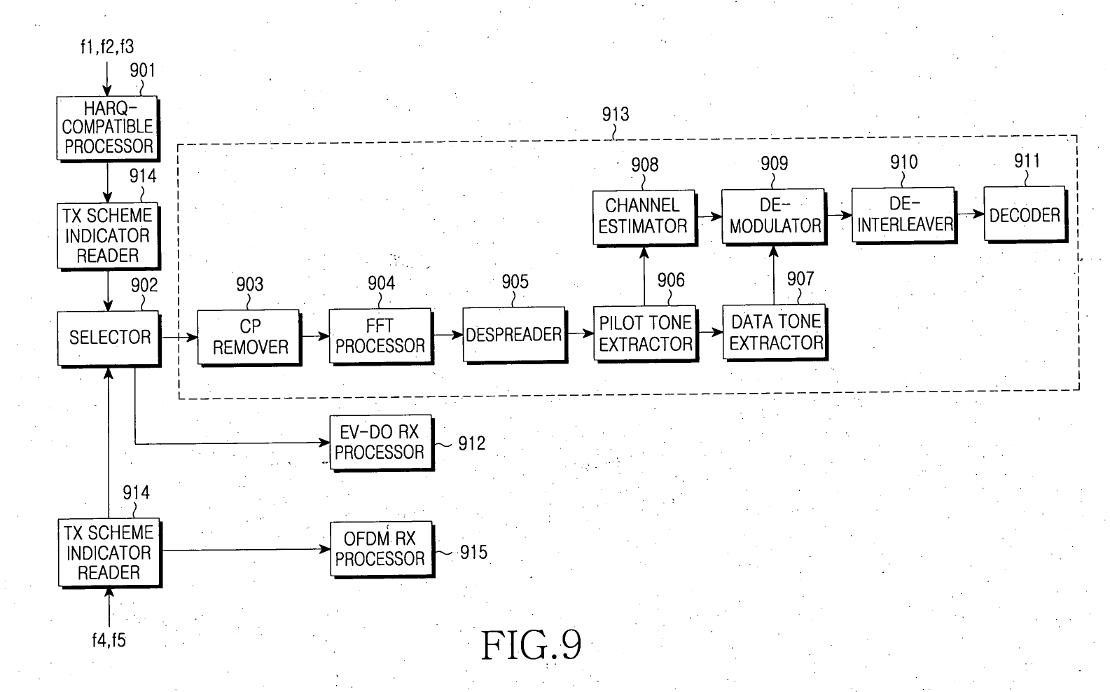

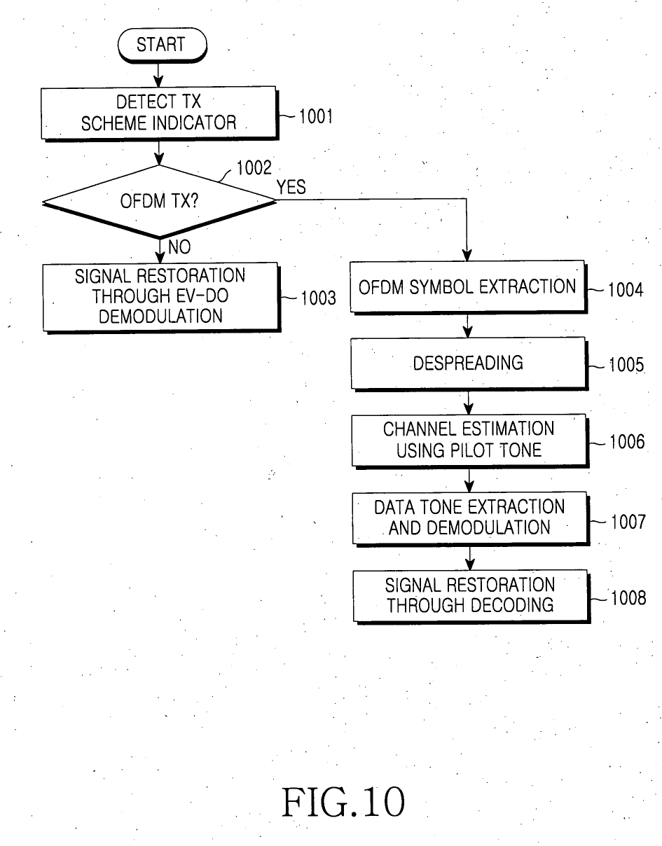

With reference to FIGS. 9 and 10, a description will now be made of the structure of a receiver according to an embodiment of the present invention.

Referring to FIG. 9, in the receiver, an HRPD-compatible processor 901 receives multiple carriers f1, f2 and f3, and demultiplexes the signals received through carriers f1, f2 and f3, thereby restoring a data signal, a MAC signal and a pilot signal. A transmission scheme indicator reader 914 reads the proposed transmission scheme indicator included in the interval of a MAC signal among the restored signals, and determines if the received signal in the current slot is a signal transmitted with the OFDM transmission scheme or a signal transmitted with the EV-DO transmission scheme.

In addition, the receiver includes an OFDM reception processor 913, an EV-DO reception processor 912, and another OFDM reception processor 915 having the same structure as the OFDM reception processor 913. OFDM reception processor 913 and EV-DO reception processor 912 are for receiving OFDM/EV-DO signals transmitted according to the slot structure of FIG. 4 or 5, and another OFDM reception processor 915 is for receiving OFDM signals of carriers f4 and f5 transmitted according to the slot structure of FIG. 6.

An operation of OFDM reception processor 913 will first be described. A selector 902 delivers, to the OFDM reception processor 913, a received signal, which is determined by transmission scheme indicator reader 914 as an indicator indicating the OFDM transmission scheme. The received signal is delivered to a CP remover 903, and CP remover 903 removes from the received signal a CP contaminated due to propagation delay and multiple paths. An FFT processor 904 converts an input time-domain signal into a frequency-domain signal, and a despreader 905 despreads the frequency-domain signal and outputs tones of each signal. The despreader 905 performs QPSK despreading on the assumption that a transmitter has transmitted QPSK-spread signals. Therefore, if the transmitter uses another spreading scheme, the receiver also uses its associated despreading scheme. Tones of the despread signal are delivered to a pilot tone extractor 906 and a data tone extractor 907, and data tone extractor 907 extracts data tone from the received signal. A channel estimator 908 estimates a channel from a pilot signal delivered from pilot tone extractor 906, and delivers the channel-estimated value to a demodulator 909. Demodulator 909 performs demodulation on the data tones using the channel-estimated value provided from channel estimator 908, and the demodulated signal is deinterleaved by a deinterleaver 910 and then input to a decoder 911. Decoder 911 restores the received signal by decoding the input signal.

An operation of the EV-DO reception processor 912 will now be described. Selector 902 delivers, to the EV-DO reception processor 912, a received signal, which is determined by the transmission scheme indicator reader 914 as an indicator indicating the EV-DO transmission scheme. Then EV-DO reception processor 912 performs demodulation corresponding to the EV-DO scheme on the received signal.

When the receiver supports the embodiment of FIG. 6, transmission scheme indicator reader 914 reads a transmission scheme indicator inserted in an arbitrary OFDM symbol transmitted on carriers f4 and/or f5, and determines a transmission scheme of the signals received on carriers f1, f2 and f3. Then selector 902 selects one of the OFDM reception processor 913 and EV-DO reception processor 912 as a reception path of the OFDM/EV-DO signals according to the transmission scheme read by transmission scheme indicator reader 914. In addition, another OFDM reception processor 915 restores OFDM signals received on carriers f4 and f5.

Referring to FIG. 10, in step 1001, a receiver detects a transmission scheme indicator from a received signal, and determines if a transmission scheme of the received signal is an OFDM transmission scheme or an EV-DO transmission scheme. This depends on the embodiments of reading a transmission scheme indicator indicating the transmission scheme, and in the present invention, the receiver can determine the transmission scheme of the received signal by parsing a transmission scheme indicator included in a MAC interval in the slot structure of FIG. 4 or 5, or parsing a transmission scheme indicator included in an arbitrary OFDM symbol in the slot structure of FIG. 6. In step 1002, the receiver determines the transmission scheme depending on a transmission scheme indicator read by a transmission scheme indicator reader 914 and restores the received signal according to the determined transmission scheme. If it is determined in step 1002 that the determined transmission scheme is the EV-DO transmission scheme, the receiver proceeds to step 1003 where it performs EV-DO demodulation. However, if the determined transmission scheme is the OFDM transmission scheme, the receiver performs an operation of steps 1004 to 1008 in which the receiver extracts an OFDM symbol, performs QPSK despreading, performing channel estimation using pilot tones, and extracts data tones from the received signal using the estimated channel information. In addition, the receiver restores the original signal by demodulating and decoding the extracted data tones.

As can be understood from the foregoing description, in the mobile communication system supporting both the EV-DO transmission scheme and the OFDM transmission scheme, both of which maintain compatibility with the Nx HRPD system, the transmitter inserts a transmission scheme indicator to be used in a slot of each carrier, into a MAC interval or an OFDM symbol of an EV-DO slot structure before transmission, and the receiver can receive data on the corresponding slot depending on the transmission scheme indicator received. Therefore, the present invention supports different transmission schemes for slots of multiple carriers in the Nx HRPD system, thereby providing improved HRPD services.

Although the transmission scheme indicator described in FIGS. 4 to 6 is inserted in the MAC interval of each slot, or the OFDM symbol of the carriers f4 and f5 after undergoing block coding, this is not intended to limit the invention and various changes in the arrangement of the transmission scheme indicator is possible. While the invention has been shown and described with reference to a certain preferred embodiment thereof, it will be understood by those skilled in the art that various changes in form and details may be made therein without departing from the spirit and scope of the invention as further defined by the appended claims.

What is claimed is:

1. A transmission apparatus for transmitting packet data in a forward link of a High Rate Packet Data (HRPD) system, the apparatus comprising:
a first transmission processor for modulating physical link packet data according to an Orthogonal Frequency Division Multiplexing (OFDM) transmission scheme;
a second transmission processor for modulating the physical link packet data according to a Evolution Data Only (EV-DO) transmission scheme;
an HRPD-compatible processor for generating a signal output from one of the first and second transmission processors into a transmission signal based on a slot structure of the HRPD system, and transmitting the transmission signal to a wireless network; and
a controller for controlling transmission of the transmission signal according to a one of the OFDM transmission scheme and the EV-DO transmission scheme.

2. The transmission apparatus of claim 1, further comprising:
a selector for selecting one of modulated signals of the first and second transmission processors,
wherein the controller controls an operation of the selector.

3. The transmission apparatus of claim 1, wherein the controller controls a transmission scheme indicator indicating the one of the OFDM transmission scheme and the EV-DO transmission scheme being inserted into the transmission signal.

4. The transmission apparatus of claim 3, further comprising a transmission scheme indicator inserter for inserting the transmission scheme indicator into the transmission signal under a control of the controller.

5. The transmission apparatus of claim 4, wherein the transmission scheme indicator inserter inserts the transmission scheme indicator into the transmission signal after block coding the transmission scheme indicator.

6. The transmission apparatus of claim 3, wherein the controller is further configured to insert the transmission scheme indicator into at least one Medium Access Control (MAC) interval of the slot structure.

7. The transmission apparatus of claim 1, further comprising:
a third transmission processor for modulating another physical link packet data according to the OFDM transmission scheme,
wherein the controller is further configured to insert a transmission scheme indicator indicating a selected transmission scheme of the transmission signal into another transmission signal of the third transmission processor.

8. The transmission apparatus of claim 7, wherein the controller is further configured to insert the transmission scheme indicator into an OFDM symbol of a corresponding slot interval in another transmission signal.

9. The transmission apparatus of claim 1, wherein the controller selects a transmission scheme of the transmission signal based on forward channel information.

10. The transmission apparatus of claim 1, wherein the controller can separately select for each carrier a transmission scheme of the transmission signal in a same slot interval.

11. A transmission method for transmitting packet data in a forward link of a High Rate Packet Data (HRPD) system, the method comprising:
selecting one transmission scheme among an Orthogonal Frequency Division Multiplexing (OFDM) transmission scheme and an Evolution Data Only (EV-DO) transmission scheme;
modulating physical link packet data according to the selected transmission scheme;
generating the modulated packet data into a transmission signal based on a slot structure of the HRPD system; and
transmitting the transmission signal to a wireless network on a slot by slot basis.

12. The transmission method of claim 11, wherein the generating step further comprises inserting into the transmission signal a transmission scheme indicator indicating the selected transmission scheme.

13. The transmission method of claim 12, wherein the inserting step further comprises block-coding the transmission scheme indicator.

14. The transmission method of claim 12, wherein the transmission scheme indicator is inserted into at least one Medium Access Control (MAC) interval of the slot structure.

15. The transmission method of claim 11, further comprising:
generating another transmission signal by modulating another physical link packet data according to the OFDM transmission scheme; and
inserting a transmission scheme indicator indicating the selected transmission scheme of the transmission signal into another transmission signal.

16. The transmission method of claim 15, wherein the transmission scheme indicator is inserted into an OFDM symbol of another transmission signal.

17. The transmission method of claim 11, further comprising selecting the transmission scheme of the transmission signal based on forward channel information.

18. The transmission method of claim 11, wherein the transmission scheme can be separately selected for each carrier in a same slot interval.

19. A reception apparatus for receiving packet data in a forward link of a High Rate Packet Data (HRPD) system, the apparatus comprising:
an HRPD-compatible processor for receiving a forward link signal according to a slot structure of the HRPD system;
a first reception processor for demodulating a received signal according to an Orthogonal Frequency Division Multiplexing (OFDM) transmission scheme;
a second reception processor for demodulating a received signal according to an Evolution Data Only (EV-DO) transmission scheme; and
a selector for selecting one of the first and second reception processors as a reception path according to a transmission scheme of the forward link signal.

20. The reception apparatus of claim 19, wherein the forward link signal includes a transmission scheme indicator indicating the transmission scheme.

21. The reception apparatus of claim 20, further comprising a reader for reading the transmission scheme indicator from the forward link signal and delivering the read result to the selector.

22. The reception apparatus of claim 20, wherein the transmission scheme indicator is inserted into at least one Medium Access Control (MAC) interval of the slot structure.

23. The reception apparatus of claim 19, further comprising:
a third reception processor for receiving another forward link signal transmitted through the OFDM transmission scheme, and demodulating the another forward link signal,
wherein the another forward link signal includes a transmission scheme indicator indicating the transmission scheme of the forward link signal.

24. The reception apparatus of claim 23, wherein the transmission scheme indicator is inserted into an OFDM symbol of a corresponding slot interval in the another forward link signal.

25. A reception method for receiving packet data in a forward link of a High Rate Packet Data (HRPD) system, the method comprising:
receiving a forward link signal which is transmitted according to a selected transmission scheme among an Orthogonal Frequency Division Multiplexing (OFDM) transmission scheme and an Evolution Data Only (EV-DO) transmission scheme according to a slot structure of the HRPD system;
reading a transmission scheme indicator of the forward link signal; and
demodulating the received forward link signal according to the selected transmission scheme corresponding to the read result.

26. The reception method of claim 25, wherein the forward link signal includes a transmission scheme indicator indicating the selected transmission scheme.

27. The reception method of claim 26, wherein the transmission scheme indicator is inserted into at least one Medium Access Control (MAC) interval of the slot structure.

28. The reception method of claim 25, further comprising:
receiving another forward link signal transmitted through the OFDM transmission scheme,
wherein the another forward link signal includes a transmission scheme indicator indicating the selected transmission scheme of the forward link signal.

29. The reception method of claim 28, wherein the transmission scheme indicator is inserted into an OFDM symbol of a corresponding slot interval in the another forward link signal.
